(19) United States
(12) Patent Application Publication
(10) Pub. No.: US 2017/0192886 A1
(43) Pub. Date: Jul. 6, 2017

(54) CACHE MANAGEMENT FOR NONVOLATILE MAIN MEMORY

(71) Applicant: HEWLETT PACKARD ENTERPRISE DEVELOPMENT LP, Houston, TX (US)

(72) Inventors: Hans Boehm, Palo Alto, CA (US); Naveen Muralimanohar, Santa Clara, CA (US)

(21) Appl. No.: 15/325,255

(22) PCT Filed: Jul. 31, 2014
(86) PCT No.: PCT/US2014/049313

§ 371 Date: Jan. 10, 2017

(51) Int. Cl. G06F 12/0804; G06F 12/0815

(52) U.S. Cl. CPC G06F 12/0804; G06F 12/0815; G06F 2212/1024; G06F 2212/205

(57) ABSTRACT

A coherence logic of a first core in a multi-core processor receives a request to send a cache line to a second core in the multi-core processor. In response to receiving the request, the coherence logic determines if the cache line is associated to a logically nonvolatile virtual page mapped to a nonvolatile physical page in a nonvolatile main memory. If so, the coherence logic flushes the cache line from the cache to the nonvolatile main memory and then sends the cache line to the second core.

### BACKGROUND

A multi-core processor includes multiple cores each with its own private cache and a shared main memory. Unless care is taken, a coherence problem can arise if multiple cores have access to multiple copies of a datum in multiple caches and at least one access is a write. The cores utilize a coherence protocol that prevents any of them from accessing a stale datum (incoherency).

The main memory has traditionally been volatile. Hardware developments are likely to again favor nonvolatile technologies over volatile ones, as they have in the past. A nonvolatile main memory is an attractive alternative to the volatile main memory because it is rugged and data persistent without power. One type of nonvolatile memory is a memristive device that displays resistance switching. A memristive device can be set to an “ON” state with a low resistance or reset to an “OFF” state with a high resistance. To program and read the value of a memristive device, corresponding write and read voltages are applied to the device.

### BRIEF DESCRIPTION OF THE DRAWINGS

In the drawings:

FIG. 1 is a block diagram of a computing system in examples of the present disclosure;

FIG. 2 is a block diagram of a table lookaside buffer in examples of the present disclosure;

FIG. 3 is a block diagram of another computing system in examples of the present disclosure;

FIG. 4 is a block diagram of a tag array in examples of the present disclosure;

FIG. 5 is a flowchart of a method for a coherence logic of a core in the multi-core processor of FIG. 1 or 3 to implement a write-back prior to cache migration feature in examples of the present disclosure;

FIG. 6 is a flowchart of a method for a coherence logic of a core in the multi-core processor of FIG. 1 or 3 to implement a write-back prior to cache migration feature in examples of the present disclosure; and

FIG. 7 is a block diagram of a device for implementing a cache controller of FIG. 1 or 3 in examples of the present disclosure.

Use of the same reference numbers in different figures indicates similar or identical elements.

### DETAILED DESCRIPTION

As used herein, the term “includes” means includes but not limited to, the term “including” means including but not limited to. The terms “a” and “an” are intended to denote at least one of a particular element. The term “based on” means based at least in part on. The term “or” is used to refer to a nonexclusive such that “A or B” includes “A but not B,” “B but not A,” and “A and B” unless otherwise indicated.

A computing system with a multi-core processor may use volatile processor caches and a nonvolatile main memory. To ensure that certain data is persistent after power is turned off intentionally or otherwise, an application may explicitly write back (flush) data from a cache into the nonvolatile main memory. The flushing of data may be a performance bottleneck because flushing is performed frequently to ensure data reach the nonvolatile main memory in the correct order to maintain data consistency, and flushing any large amount of data involves many small flushes of cache lines (also known as “cache blocks”) in the cache.

One example use case of a cache line flush operation may include a core storing data of a newly allocated data object in its private (dedicated) cache, the core flushing the data from the private cache to a nonvolatile main memory, and the core storing a pointer to the data object in the processor cache in this specified order. Performing the cache line flush of the data object before storing the pointer prevents the nonvolatile main memory from having only the pointer but not the data object, which allows an application to see consistent data when it restarts after a power is turned off. Other use cases may also frequently use the cache line flush operation.

The cost of the cache line flush operation may be aggravated by a corner case where, after a first core stores (writes) data to a cache line in its private cache and before the first core can flush the cache line from its private cache, a second core accesses the cache line from the first core's private cache and stores the cache line in its own private cache without writing the cache line back to the nonvolatile main memory. When the first core tries to flush the cache line, the cache line may be located at the second core's private cache instead of the first core's private cache. Thus the first core communicates a cache line flush operation to the other cores so they will look to flush the cache line from their private caches, thereby increasing the number of cache line flushes and communication between cores.

In examples of the present disclosure, a coherence logic in a multi-core processor includes a write-back prior to cache migration feature to address the above described corner case. The write-back prior to cache migration feature causes the coherence logic of a core to flush a cache line before the cache line is sent (migrated) to another core. The write-back prior to cache migration feature prevents the above-described corner case so the core does not issue a cache line flush operations to the other cores, thereby reducing the number of cache line flushes and communication between the cores.

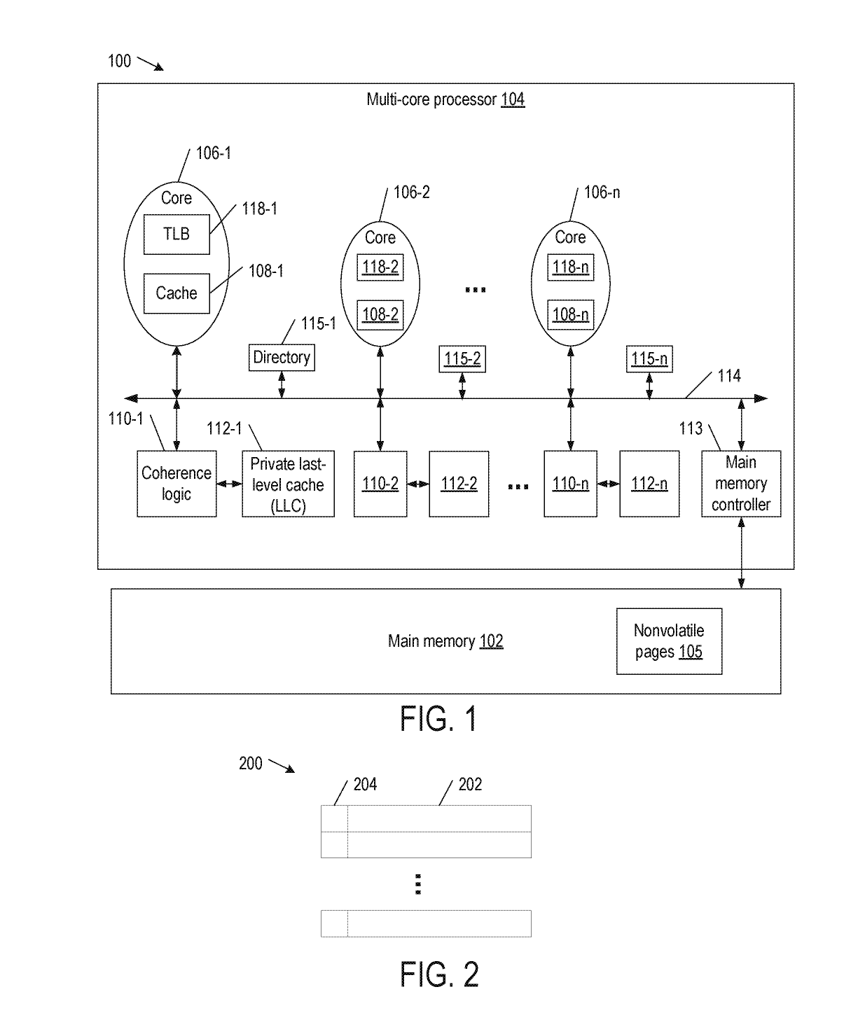

FIG. 1 is a block diagram of a computing system 100 in examples of the present disclosure. Computing system 100 includes a main memory 102 and a multi-core processor 104. Main memory 102 includes nonvolatile pages 105. Main memory 102 may also include volatile pages. For convenience, main memory 102 is referred to as “nonvolatile main memory 102” to indicate it at least includes nonvolatile pages 105.

Multi-core processor 104 includes cores 106-1, 106-2 . . . 106-n with private caches 108-1, 108-2 . . . 108-n, respectively, coherence logics 110-1, 110-2 . . . 110-n for private last level caches (LLCs) 112-1, 112-2 . . . 112-n, respectively, of cores 106-1, 106-2 . . . 106-n, respectively, a main memory controller 113, and an interconnect 114. Although a certain number of cores are shown, multi-core processor 104 may include 2 or more cores. Although two cache levels are shown, multi-core processor 104 may include more cache levels. Cores 106-1, 106-2 . . . 106-n may execute threads that include load, store, and flush instructions. Private caches 108-1 to 108-n and private LLCs 112-1 to 112-n may be write-back caches where a modified (dirty) cache line in a cache is written back to nonvolatile main memory 102 when the cache line is evicted because a new line is taking its place. LLCs 112-1 to 112-n may be inclusive caches so any cache line held in a private cache is also held in the LLC of the same core. Coherence logics 110-1 to 110-n track the coherent states of the cache lines. Coherence logics 110-1 to 110-n include a write-back prior to cache migration feature. Interconnect 114 couples cores 106-1 to 106-n, coherence logics 110-1 to 110-n, and main memory controller 113. Interconnect 114 may be a bus or a mesh, torus, linear, or ring network. Cores 106-1, 106-2 . . . 106-n may include table lookaside buffers (TLBs) 118-1, 118-2 . . . 118-n, respectively, that map virtual addresses used by software (e.g., operating system or application) to physical addresses in nonvolatile main memory 102.

FIG. 2 is a block diagram of a page table 200 in examples of the present disclosure. Page table 200 includes page table entries 202 each having a volatility bit 204 indicating if a virtual page is logically volatile or nonvolatile. Note that page table 200 may be partially stored in a TLB, private cache, LLC, or in nonvolatile main memory 102. When a virtual page is logically nonvolatile, it is to be mapped to nonvolatile physical page 105 in nonvolatile memory 102, and the write-back prior to cache migration operation is to be performed for cache lines associated to that virtual page. Instead of page table 200, specific range in the virtual addresses may be designated for nonvolatile virtual pages 105.

In examples of the present disclosure, multi-core processor 104 implements a directory-based coherence protocol using directories 115-1, 115-2 . . . 115-n. Each directory serves a range of addresses to track which cores (owners and sharers) have cache lines in its address range and coherence state of those cache line, such exclusive, shared, or invalid states. An exclusive state may indicate that the cache line is dirty.

Assume core 106-1 writes to a cache line in its private cache 108-1 and directory 115-n serves that cache line. Private cache 108-1 sends an update to directory 115-n indicating that the cache line is dirty. Assume core 106-2 wishes to write the cache line after core 106-1 writes the cache line in its private cache 108-1 but before core 106-1 can flush the cache line to nonvolatile main memory 102. Core 106-n learns from directory 115-n that the cache line is dirty and located at node 106-1, and sends a request to coherence logic 110-1 for the cache line. Implementing the write-back prior to cache migration feature in response to the request from core 106-2, coherence logic 110-1 determines if the cache line is associated with a nonvolatile virtual page based on a page table or its address. If so, coherence logic 110-1 writes the cache line back from private cache 108-1 to nonvolatile main memory 102 before sending the cache line to core 106-2. The write-back prior to cache migration feature prevents the above-described corner case so the core does not issue a cache line flush operations to the other cores, thereby reducing the number of cache line flushes and communication between the cores.

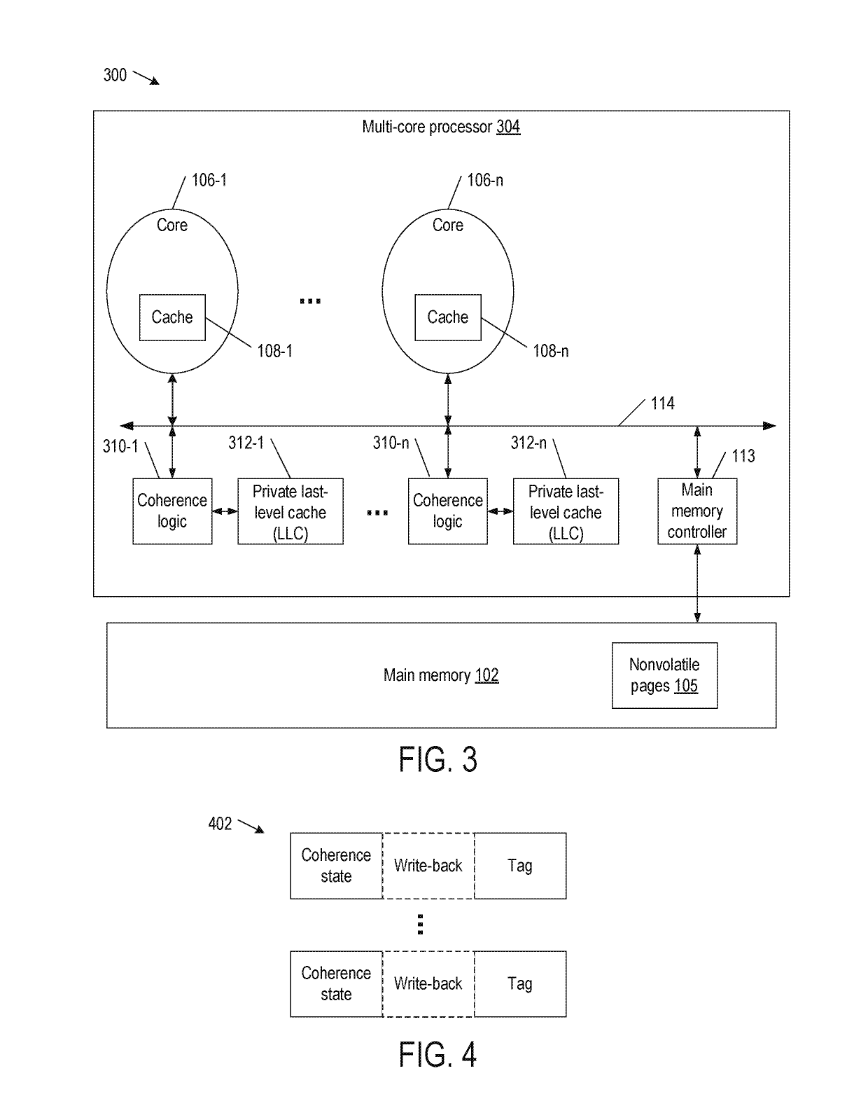

FIG. 3 is a block diagram of computing system 300 in examples of the present disclosure. Computing system 300 may be a variation of computing system 100 (FIG. 1). In computing system 300, a multi-core processor 304 replaces the multi-core processor 104 of computing system 100. Multi-core processor 304 is similar to multi-core processor 104 but has coherence logics 310-1, 310-2 . . . 310-n for LLCs 312-1, 312-2 . . . 312-n, respectively, of cores 106-1, 106-2 . . . 106-n, respectively, in place of coherence logics 110-1, 110-2 . . . 110-n for LLCs 112-1, 112-2 . . . 112-n.

In examples of the present disclosure, multi-core processor 304 implements a snoop coherence protocol. In the snoop coherence protocol, each coherence logic observes requests from the other cores over interconnect 114. A coherence logic tracks the coherence state of each cache line with a tag array 402 as shown in FIG. 4 in examples of the present disclosure. In some examples of the present disclosure, the coherence state may implicitly indicate if a cache line has been written back to nonvolatile main memory 102. In other examples, an optional write-back bit in tag array 402 explicitly indicates if a cache line has been written back to nonvolatile main memory 102.

Assume core 106-n writes to a cache line in its private cache 108-n and core 106-2 sends a broadcast for the cache line on interconnect 114 after core 106-n writes the cache line in its private cache 108-1 but before core 106-n can flush the cache line to nonvolatile main memory 102. Implementing the write-back prior to cache migration feature in response to the broadcast from core 106-2, coherence logic 310-n observes (snoops) the broadcast and determines if the cache line is dirty and located in private cache 108-n. If so, coherence logic 310-n determines if the cache line is associated with a nonvolatile virtual page based on a page table or its address. If so, coherence logic 310-n writes the cache line back from private cache 108-n to nonvolatile main memory 102 before broadcasting the cache line in reply to core 106-2.

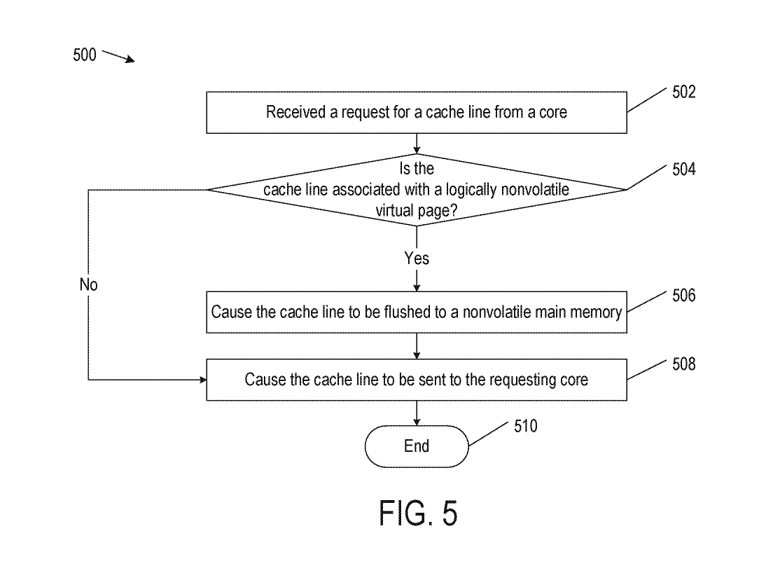

FIG. 5 is a flowchart of a method 500 for coherence logic 110-n in multi-core processor 100 (FIG. 1) or coherence logic 310-n in multi-core processor 300 (FIG. 3) to implement a write-hack prior to cache migration feature in examples of the present disclosure. Although the blocks in method 500, and any method described hereafter, are illustrated in a sequential order, these blocks may also be performed in parallel or in a different order than those described herein. Also, the various blocks may be combined into fewer blocks, divided into additional blocks, or eliminated based upon the desired implementation. Method 500 may begin in block 502.

In block 502, coherence logic 110-n or 310-n receives a request for a cache line from another core in multi-core processor 100 or 300, such as core 106-2. Block 502 may be followed by block 504.

In block 504, in response to receiving the request in block 502, coherence logic 110-n or 310-n determines if the cache line is associated with a logically nonvolatile virtual page. If so, block 504 may be followed by block 506. Otherwise block 504 may be followed by block 510, which ends method 500.

In block 506, coherence logic 110-n or 310-n writes the cache line back from the private cache to nonvolatile main memory 102. Block 406 may be followed by block 508.

In block 508, coherence logic 110-n or 310-n sends the cache line t to the requesting core 106-2. Block 508 may be followed by block 510, which ends method 500.

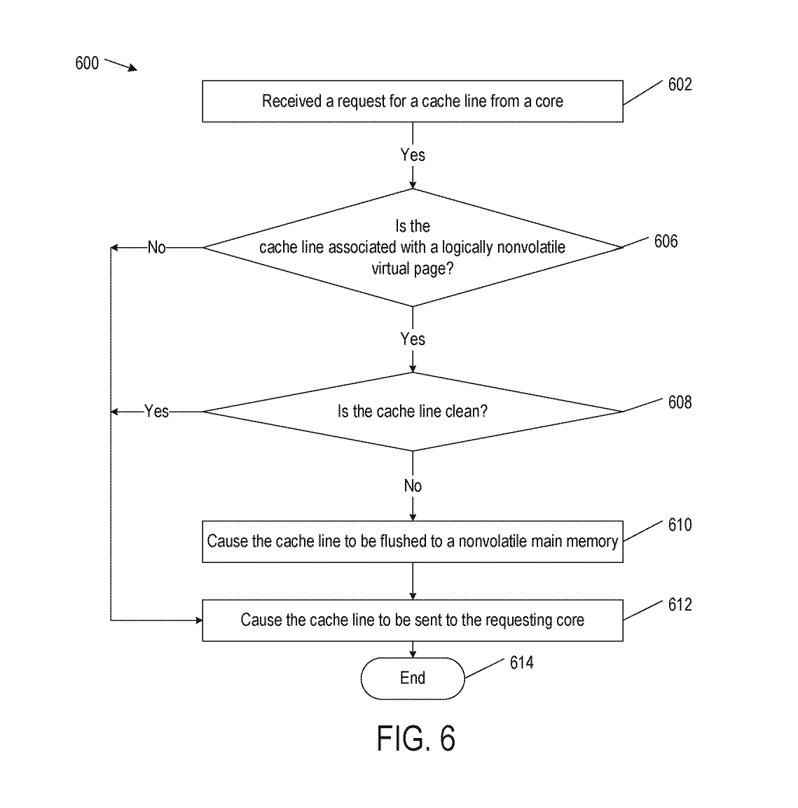

FIG. 6 is a flowchart of a method 600 for coherence logic 110-n in multi-core processor 100 (FIG. 1) or coherence logic 310-n in multi-core processor 300 (FIG. 3) to implement a write-back prior to cache migration feature in examples of the present disclosure. Method 600 is a variation of method 500 (FIG. 5). Method 600 may begin in block 602.

In block 602, coherence logic 110-n or 310-n receives a request for a cache line from another core in multi-core processor 100 or 300, such as core 106-2. The request may be a shared or exclusive request. Block 602 corresponds to block 502 (FIG. 2) of method 500. Block 602 may be followed by block 606.

In block 606, coherence logic 110-n or 310-n determines if the cache line is associated with a logically nonvolatile virtual page based on a page table or its address so the cache line is to be written back to nonvolatile main memory 102 before being sent to another core. If so, block 606 may be followed by block 608. Otherwise block 606 may be followed by block 612. Block 606 may correspond to block 504 (FIG. 5) of method 500.

In block 608, coherence logic 110-n or 310-n determines if the cache line is clean. When a directory-based coherence protocol is used, coherence logic 110-n determines if the cache line is clean from the coherent state of the cache line in its directory. If a cache line is clean, then it has not been written back to nonvolatile main memory 102. When a snoop coherence protocol is used, coherence logic 310-n determines if the cache line is clean based on the coherence state or the write-back bit of the cache line in its tag array. If the cache line is clean, block 608 may be followed by block 612. Otherwise, if the cache line is dirty and has not been written back, block 608 may be followed by block 610.

In block 610, coherence logic 110-n or 310-n writes the cache line back from private cache 108-1 to nonvolatile main memory 102. Block 610 corresponds to block 506 (FIG. 5) of method 500. Block 610 may be followed by block 612.

In block 612, coherence logic 110-n or 310-n sends the cache line to the requesting core 106-2. In some examples, coherence logic 110-n sends the cache line to core 106-2. In other examples, coherence logic 310-n broadcasts the cache line for core 106-2. Block 612 may correspond to block 508 (FIG. 5) of method 500. Block 612 may be followed by block 614, which ends method 600.

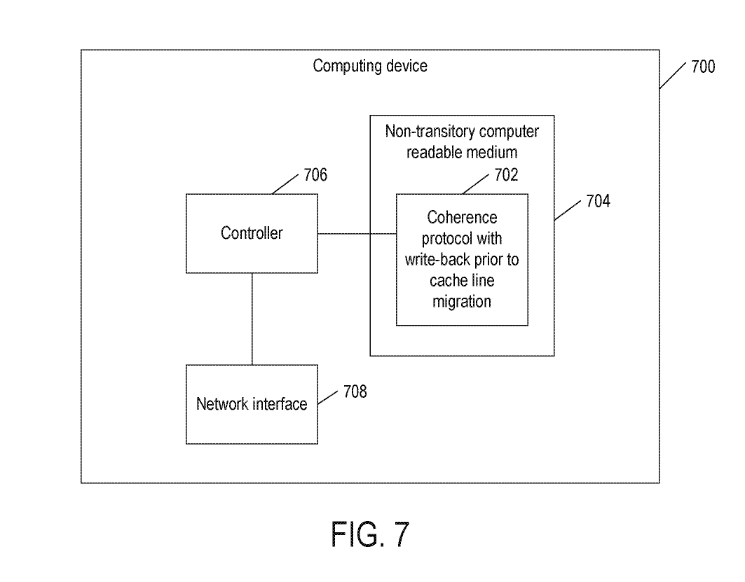

FIG. 7 is a block diagram of a device 700 for implementing a coherence logic 110-n or 310-n of FIG. 1 or 3 in examples of the present disclosure. Instructions 702 for a write-back prior to cache migration feature are stored in a non-transitory computer readable medium 704, such as a read-only memory. A processor or state machine 706 executes instructions 702 to provide the described features and functionalities. Processor or state machine 706 communicates with private caches and coherence logics via a network interface 708.

In examples of the present disclosure, processor or state machine 706 executes instructions 702 on non-transitory computer readable medium 704 to, in response to a request for a cache line from a core, determine if the cache line is associated with a logically nonvolatile virtual page that is to be written back to nonvolatile main memory before migrating to another core, determine if the cache line has been written back to a nonvolatile main memory, when the cache line has not been written back, causing the cache line to be flushed from the private cache to the nonvolatile main memory, and, after flushing the cache line, cause the cache line to be sent to the requesting core.

Although multi-core processor 104 is shown with two levels of cache, the concepts described hereafter may be extended to multi-core processor 104 with additional levels of cache. Although multi-core processor 104 is shown with dedicated LLCs 112-1 to 112-n, the concepts described hereafter may be extended to a shared LLC.

Various other adaptations and combinations of features of the examples disclosed are within the scope of the invention.

What is claimed is:

1: A method for a coherence logic of a core in a multi-core processor, comprising:
receiving a request for a cache line from another core in the multi-core processor;
in response to the request, determining if the cache line is associated to a nonvolatile virtual page mapped to a nonvolatile physical page in a nonvolatile main memory; and
when the cache line is associated to the nonvolatile virtual page mapped to the nonvolatile physical page in the nonvolatile main memory:
writing the cache line back from a private cache of the core to the nonvolatile main memory; and
after the cache line is flushed, causing the cache line to be sent to the requesting core.

2: The method of claim 1, further comprising, before causing the cache line to be flushed, determining the cache line is associated to the nonvolatile virtual page mapped to the nonvolatile physical page in the nonvolatile main memory based on a page table entry or an address of the cache line.

3: The method of claim 1, wherein receiving the request for the cache line comprises the coherence logic receiving the request for the cache line from the other node over an interconnect to implement a directory-based coherence protocol.

4: The method of claim 1, wherein receiving the request for the cache line comprises snooping the request from a bus to implement a snoop coherence protocol.

5: The method of claim 1, wherein the request comprises a shared request or an exclusive request for the cache line.

6: A multi-core processor, comprising:
a first core with a first private cache;
a first coherence logic for a first private last level cache (LLC) of the first core;
a second core with a second private cache;
a second coherence logic for a second private LLC of the second core;
a main memory controller for a nonvolatile main memory including nonvolatile pages; and
an interconnect coupling the first core, the first coherence logic, the second core, the second coherence logic, and the main memory controller,
wherein each coherence logic is configured to cause a cache line to be written back from one private cache to the nonvolatile main memory before causing the cache line to be sent to another core in response to a request for the cache line when the cache line is dirty.

7: The multi-core processor of claim 6, wherein:
each coherence logic is configured to, before causing the cache line to be flushed, determine the cache line is associated to the nonvolatile virtual page mapped to the nonvolatile physical page in the nonvolatile main memory based on a page table entry or an address of the cache line.

8: The multi-core processor of claim 6, wherein:
the interconnect is a bus; and
each coherence logic is configured to snoop the request from the bus to implement a snoop coherence protocol.

9: The multi-core processor of claim 6, wherein each coherence logic is configured to observe the request on the interconnect to implement a directory-based coherence protocol.

10: The multi-core processor of claim 6, wherein the request comprises a shared request or an exclusive request for the cache line.

11: A non-transitory computer readable medium encoded with instructions executable by a processor to:
in response to a request for a cache line from a core, determine if the cache line is associated to a nonvolatile virtual page mapped to a nonvolatile physical page in a nonvolatile main memory; and
when the cache line is associated to the nonvolatile virtual page mapped to the nonvolatile physical page in the nonvolatile main memory:
determine if the cache line has been written back to the nonvolatile main memory;
when the cache line has not been written back to the nonvolatile main memory:
cause the cache line to be written back from the private cache of the other node to the nonvolatile main memory when the cache line has not been written back to the nonvolatile main memory; and
after causing the cache line to be flushed, send the cache line to the requesting core.

12: The non-transitory computer readable medium of claim 11, wherein the instructions are further executable by the processor to, before writing the cache line back, determining the cache line is associated to the nonvolatile virtual page mapped to the nonvolatile physical page in the nonvolatile main memory based on a page table entry or an address of the cache line.

13: The non-transitory computer readable medium of claim 11, wherein the instructions are further executable by the processor to serve as a home node to receive the request from the interconnect to implement a directory-based coherence protocol or

14: The non-transitory computer readable medium of claim 11, wherein the instructions are further executable by the processor to snoop the request from a bus to implement a snoop coherence protocol.

15: The non-transitory computer readable medium of claim 11, wherein the request comprises a shared request or an exclusive request for the cache line.
